(19) United States
(12) Patent Application Publication
(10) Pub. No.: US 2001/0003389 A1
(43) Pub. Date: Jun. 14, 2001

(54) HIGH TEMPERATURE STATIC SEAL

(75) Inventor: JOEL J. PIPPERT, HOUSTON, TX (US)

Correspondence Address: C JAMES BUSHMAN, BROWNING BUSHMAN, 5718 WESTHEIMER, SUITE 1800, HOUSTON, TX, 77057

(73) Assignee: C. JAMES BUSHMAN

(21) Appl. No.: 09/250,536

(22) Filed: Feb. 16, 1999

(51) Int. Cl. F16J 15/10

(52) U.S. Cl. 277/627

(57) ABSTRACT

A seal member having an inner core comprised of a plurality of core elements, the core elements comprising a flexible mineral yarn and a flexible metallic sheath formed from a network of strands of a first metal, the mineral yarn being encased in the sheath and a flexible outer jacket in surrounding relationship to the inner core, the outer jacket being formed of a network of strands of a second metal.

### BACKGROUND OF THE INVENTION

1. Field of the Invention

The present invention relates to gaskets or similar, static joint seals and, more particularly, to such seals for use in high temperature, high pressure applications.

2. Description of the Prior Art

As is well known to those skilled in the art, there are numerous applications for static seals, such as gaskets, to provide fluid-tight pressure seals between adjacent surfaces of various components. Typical of such applications are gaskets compressed between adjoining pipe flanges, the pipe flanges being urged together—e.g., by bolt-nut combinations or the like—the gasket being compressed between the flange faces to form a static, fluid-pressure seal. In many cases, seals of the type under consideration are used in environments of high temperature and high pressure. Accordingly, materials such as rubber, synthetic polymers, or the like are not suitable as they cannot withstand the high temperatures and/or pressures involved. For many years, gaskets for use in high temperature, high pressure environments typically were comprised of asbestos. However, because of the health concerns associated with asbestos, its use in the manufacture of gaskets has largely been discontinued in favor of materials such as ceramic fibers, inorganic fibers, mineral yarns, and the like. U.S. Pat. No. 5,225,262 discloses a braided packing having a core formed from strands of a graphite tape overknitted with a reinforcing wire and a jacket of an inorganic fiber or the like disposed about the core.

### SUMMARY OF THE INVENTION

It is therefore an object of the present invention to provide a high temperature, high pressure seal member.

Another object of the present invention is to provide a seal member having an inner core incorporating a metallic reinforcing material and an outer jacket of a metallic material.

The above and other objects of the present invention will become apparent from the drawings, the description given herein, and the appended claims.

According to the present invention, there is provided a seal member that can be in the form of a strip, tape, rope, or the like and that has an inner core comprised of a plurality of core elements, the core elements including a flexible mineral yarn or threads, such as expanded graphite, and a flexible metallic sheath formed of a network of strands of a first metal, the mineral yarn being encased in the sheath, and a flexible outer jacket in surrounding relationship to the inner core, the outer jacket being formed of a network of strands of a second metal. Preferably, the first and second metals are corrosion-resistant, and a corrosion inhibitor is incorporated into the seal member, comprised of the core and the outer jacket. Additionally, and preferably, there is incorporated a binder/lubricant that is resistant to high temperatures and that acts to hold the components of the seal member in a cohesive, substantially solid body, as well as providing a lubricating action to the seal member.

### BRIEF DESCRIPTION OF THE DRAWINGS

FIG. 1 is a perspective view of a section of a seal member in accordance with the present invention;

FIG. 2 is a perspective view showing in simplistic form a core element comprised of a flexible mineral yarn and a surrounding flexible metal sheath; and

FIG. 3 is a perspective view of a flange showing a seal member in the form of a gasket according to the present invention disposed thereon.

### DESCRIPTION OF THE PREFERRED EMBODIMENTS

The seal member of the present invention comprises two primary components: a flexible inner core and a flexible outer jacket that surrounds the inner core. The inner core is comprised of a plurality of elongate core elements, the core elements comprising a flexible mineral yarn and a flexible metallic sheath that is formed from a network of strands of a first metal, the metal sheath essentially forming a tubular structure in which is received the flexible metal yarn. Essentially, the metal yarn is wrapped or encased in the flexible metal sheath. The flexible outer jacket that surrounds the inner core is formed of a network of strands of a second metal, the flexible outer jacket likewise being essentially in the form of a tubular structure.

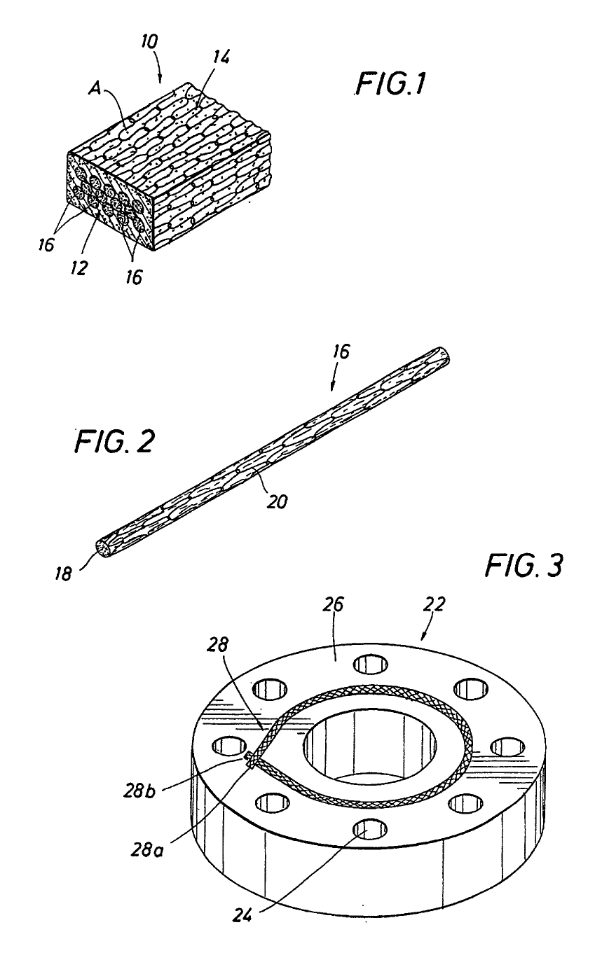

With reference first to FIG. 1, the gasket shown generally as 10 is comprised of an inner core indicated generally as 12 and an outer jacket indicated generally as 14. The inner core 12 is comprised of a plurality of core elements 16. As shown in FIG. 2, each of core elements 16 is comprised of a flexible yarn 18 that is received in a flexible metallic sheath 20, sheath 20 being formed from a network of strands of a first metal in an elongate, tubular configuration, yarn 18 being received in sheath 20—i.e., sheath 20 is disposed in generally surrounding relationship to yarn 18.

The term “yarn” is intended to include a single element—e.g., a thread—or multiple elements—e.g., multiple threads—that can be twisted along their length—i.e., intertwined—or can simply be disposed in generally parallel side-by-side relationship to achieve the desired thickness. An example of a suitable core element is disclosed in U.S. Pat. No. 4,961,988, incorporated herein by reference for all purposes. As can be seen in the latter patent, the core element can comprise an expanded graphite comprising mainly the vermiform laminae of expanded graphite and auxiliary materials wherein the auxiliary materials can be impregnated or coated with an organic adhesive into the vermiform graphite laminae, the laminae being bonded together with a suitable organic adhesive.

The term “network” as used herein refers to an interlacing, interlocking, intertying, or intertwining of strands, fibers, threads, filaments, or other such generally fine, flexible, elongate members of the particular material—e.g., the metallic sheath or the outer jacket. Preferably, the flexible metallic sheath is either in the form of a knitted or braided tube through which the yarns 18 extend, although is it contemplated that the metal sheath may not be in tubular form but could be in sheet form and wrapped around the yarn to encase the yarn. In any event, however, the yarn is encased in the metal sheath, the resulting core element will generally form a substantially solid strand. As noted, preferably the flexible metallic sheath is formed by knitting or braiding of metallic wire and, in the case of being knitted, will generally consist of a continuous series of interlocking loops knitted in a tubular form, allowing two-way movement in the wire plane to give the resulting filament flexibility and resiliency, even under heavy compression loading and exposure to extreme temperatures.

Non-limiting examples of mineral yarns that can be employed include expanded graphite, expanded mica, silicon nitride and other flexible ceramic fibers, glass fibers, or any other generally inorganic substance that can be formed into flexible fibers, strands, threads, or the like.

Although the core elements can be aligned generally parallel to one another to form the inner core, preferably the core elements are intertwined along their long axis, as, for example, by braiding, as shown, for example, in U.S. Pat. No. 5,134,030, incorporated herein by reference for all purposes.

The metallic sheath can be formed of virtually any metal that can be drawn into wire such that it can be networked to form a fabric-like structure—e.g., a knitted or braided structure as described above. Thus, metals such as stainless steel, aluminum, copper, and alloys, particularly ductile alloys that are corrosion-resistant, such as INCONEL®, can be employed. Depending upon the temperature environments encountered, the metal sheath can also include synthetic fibers and polymers.

Although it is possible for the core elements comprised of the mineral yarn and the metallic sheath to be formed into a cohesive member by a mechanical force—e.g., drawing a mineral yarn and metal sheath through dies or the like so as to exert a mechanical force and physically bond the yarn to the metal sheath—it is more preferable, as disclosed in U.S. Pat. No. 4,961,988, to incorporate a binder or adhesive so that the yarn and metallic sheath can be adhesively bonded together by means of the binder.

The outer jacket is also flexible in nature and is formed of strands, wires, or filaments of a second metal, which can be the same as the first metal, that are networked together, preferably either braided or knitted, particularly as the latter term is discussed above with respect to the metallic sheath. As noted, the second metal can be the same as the first metal but is preferably corrosion-resistant, a particularly desirable combination being that the metal sheath is formed of a corrosion-resistant, nickel-containing alloy (INCONEL®) while the outer jacket is formed of knitted stainless steel. It will be appreciated that other metals can be employed as the second metal and, as in the case of the first metal, need not be corrosion-resistant. As can be seen from FIG. 1, the metal jacket is in surrounding relationship to the inner core. Once again, while it is possible to physically bind the outer jacket to the inner core by the exertion of force—e.g., a calendar die—in the preferred case, a binder/lubricant, such as described more fully hereafter, is used to assist in bonding the outer jacket to the inner core. With reference to FIG. 1 it can be seen that when the gasket is formed, whether it be by physically binding together the inner core and the outer jacket or by the use of a binder, there is formed a substantially solid body.

In the preferred case, the seal member is formed as a strip, preferably in the form of a tape or rope that can be put on a reel such that a desired length can be cut and then shaped into a desirable form for use in forming a gasket between adjacent surfaces of mating components. It will be understand that while, as shown in FIG. 1, the seal member may be in strip form having a generally rectangular in cross-section, any cross-sectional configuration can be employed. Thus, it can be circular, oval, or a variety of other shapes, in cross-sectional configuration, the only requisite being that the outer jacket surround the inner core. Conveniently, the seal member is formed into a solid body of rectangular configuration, or at least a configuration having one substantially flat surface such that the flat surface—e.g., top surface A in FIG. 1—can be coated with a pressure-sensitive adhesive.

In FIG. 3 there is shown a typical flange, indicated generally as 22, having a series of bolt holes 24 such that the flange can be mated to an adjacent flange (not shown) by means of a bolt/nut arrangement. Flange 22 has a surface 26 that would mate with a similar surface of an adjacent flange (not shown). It will be appreciated that flange 22 and an adjoining or adjacent flange would be attached to a pipe or some other such conduit carrying fluids. Obviously, in order to prevent leakage, sealing would have to be accomplished between flange 22 and the adjacent flange. To this end, the desired length of seal member, indicated as 28 in FIG. 3, would be cut. Since the tape or rope is flexible, it could be formed into the generally circular configuration shown in FIG. 3 with the ends 28a and 28b overlapped, thereby formed an endless gasket. Since the gasket is compressible, when another flange is adjoined to flange 22 as by a series of nuts and bolts using bolt holes 24 with mating bolt holes in the adjacent flange, the two flanges can be tightly compressed such that the gasket 28 will be compressed to form a fluid-tight seal between flange face 26 and the flange face of the adjacent, mating flange. Since the gasket 28 is compliant when compressed between mating flanges or the surfaces of other components, it will fill scratches and pits, will seal between warped surfaces, and in general will conform to the surface geometry of the mating surfaces between which it is positioned. It will be recognized that as opposed to overlapping ends 28a and 28b, it is possible to cut ends 28a and 28b on a bias, the ends overlapping slightly such that when the gasket is compressed, there will be no gaps, and a complete annular, fluid-tight seal will be formed.

Various additives can be incorporated into the seal member—i.e., the inner core and/or the outer jacket, as discussed in U.S. Pat. Nos. 4,961,988; 5,134,030; and 5,225,262, all of which are incorporated herein by reference. Thus, for example, corrosion inhibitors such as zinc powder, various molybdates, and the like can be incorporated to help resist corrosion. Also, fillers, such as carbon black, fumed silica, and the like, can be incorporated, if necessary, to accommodate special environments. Lubricants such as PTFE, colloidal graphite, tungsten, or molybdenum disulfide, etc., can also be used. Indeed, any number of additives can be incorporated into the seal member, provided that the seal member remains flexible and compliant so as to retain the ability to conform to the surfaces between which it forms a seal.

To form the seal member of the present invention, a loose braid is formed of the core elements, the braided core elements forming a generally rectangular structure although, as noted above, other configurations can be utilized as well. A sock or similar tubular structure of knitted wire forming the outer jacket is then pulled over the inner core, or the jacket may be knitted or braided over the inner core. It will be appreciated that at this point the outer jacket fits loosely over the inner core—i.e., the two components are not tightly bound to one another—to form a substantially solid structure. The combination of the inner core and the loose-fitting outer jacket (seal member precursor) is then dipped into an aqueous disperser containing about 20 to 30% by weight PTFE, about 10 to 15% by weight zinc powder, and about 10 to 15% by weight graphite powder. Preferably, the dipping step is conducted several times to ensure that from about 40 to 50% of the dispersion is picked up by the seal member. The seal member that has been thus dipped is then dried in a recirculating air oven or the like at a temperature of from about 150 to about 250° F. The impregnated, seal member precursor is then run through a calendar die, forming press, or the like to form the seal member into an essentially solid body, which, as noted above, can have many cross-sectional shapes, depending upon the type of die used, the desired shape of the seal member, etc. The finished seal member is then wound onto a reel or the like such that, as described above, desired lengths can be cut off to be formed into circular gaskets or other such static sealing members.

Although it will be appreciated that numerous different types of metals and yarns and combinations thereof can be used in making gaskets to suit particular needs, one gasket construction that has been found to be quite useful over a wide range of operating conditions is marketed under the trademark THERMEX, Style 482, by Utex Industries, Inc. THERMEX, Style 482, has a density of 109 lbs/cu. ft. (1.76 g/cm³) and is operable over the following service limits:

Service Limits

| | |
|---|---|
| pH Range | 1-14 |
| Temperature Limits | 1200° F. (649° C.) in steam |
| | 850° F. (454° C.) in air |
| Pressure Limit | 1000 psi/69 bar/70.3 kg/cm² |
| Max PT, Pressure @ Temperature | 500 psi @ 500° F. |
| | 34.5 bar @ 260° C. |
| | 35.15 kg/cm² @ 260° C. |

Style 482 utilizes core elements formed of an exfoliated or expanded graphite yarn and has a reinforcing jacket or metallic sheath knitted of INCONEL® wire. This core material is braided and formed into a rope of core material, which is then covered with a flexible outer jacket of knitted, 300 series stainless steel.

The foregoing description and examples illustrate selected embodiments of the present invention. In light thereof, variations and modifications will be suggested to one skilled in the art, all of which are in the spirit and purview of this invention.

What is claimed is:

1. A seal member, comprising:
an inner core, said inner core comprising a plurality of core elements, said core elements comprising a flexible mineral yarn, and a flexible metallic sheath formed from a network of strands of a first metal, said mineral yarn being encased in said sheath; and
a flexible outer jacket in surrounding relationship to said inner core, said outer jacket being formed of a network of strands of a second metal.

2. The seal member of claim 1 wherein said core elements are intertwined.

3. The seal member of claim 2 wherein said core elements are braided.

4. The seal member of claim 1 wherein said metal sheath is knitted.

5. The seal member of claim 1 wherein said metal sheath is braided.

6. The seal member of claim 1 wherein said mineral yarn comprises expanded graphite.

7. The seal member of claim 1 wherein said mineral yarn comprises expanded mica.

8. The seal member of claim 1 wherein said first metal is corrosion-resistant.

9. The seal member of claim 8 wherein said first metal comprises a nickel-containing alloy.

10. The seal member of claim 1 wherein said jacket is braided.

11. The seal member of claim 1 wherein said jacket is knitted.

12. The seal member of claim 1 wherein said second metal is corrosion-resistant.

13. The seal member of claim 1 wherein said first and second metals are the same.

14. The seal member of claim 1 wherein said inner core and said outer jacket are tightly bound together to form substantially a solid body.

15. The seal member of claim 1 wherein a corrosion inhibitor is incorporated into said inner core and said outer jacket.

16. The seal member of claim 1 wherein a binder is incorporated into said inner core and said outer jacket.

17. The seal member of claim 14 wherein said solid body is in the form of a strip, said elongate strip having at least one surface carrying a pressure-sensitive adhesive.

18. The seal member of claim 14 wherein said solid body is in the form of a tape that can be carried on a reel.
